(19) United States
(12) Patent Application Publication
(10) Pub. No.: US 2017/0267447 A1
(43) Pub. Date: Sep. 21, 2017

(54) SUBSEA PLATFORM

(71) Applicant: SUBHYDRO AS, Oslo (NO)

(72) Inventor: Rainer SCHRAMM, Frankfurth am Main (DE)

(73) Assignee: SUBHYDRO AS, Oslo (NO)

(21) Appl. No.: 15/532,113

(22) PCT Filed: Dec. 2, 2015
(86) PCT No.: PCT/NO2015/050236

§ 371 Date: Jun. 1, 2017

(30) Foreign Application Priority Data
Dec. 2, 2014 (NO) 20141458

(51) Int. Cl. B65D 88/78; B65D 88/06; E02D 29/09; B65D 90/54; F17C 3/00; E02D 27/52; B65D 90/12; B65D 90/32

(52) U.S. Cl. CPC B65D 88/78; B65D 90/12; B65D 88/06; B65D 90/32; B65D 90/54; F17C 3/005; E02D 27/52; E02D 29/06; F17C 2270/0554; F17C 2201/0104; F17C 2205/0323; F17C 2205/0352; F17C 2209/21; F17C 2209/22

(57) ABSTRACT

A subsea tank element comprises at least one tank section (1), the tank section(s) forming a cylindrical concrete-tank (2) closed at its opposite ends by two end caps (12). The tank element further comprises a rectangular structure (3, 4, 5) surrounding the cylindrical tank (2), and a connection (150, 160) between the rectangular structure (3, 4, 5) and the cylindrical tank (2) permitting a motion of the wall of the cylindrical tank (2) within predetermined limits for deflection of the rectangular structure (3, 4, 5). Permanent ballast (6, 7) and a ballast tank (8) control buoyancy and ensure static stability. Post tensioning cables through channels 9 tie the parts into a tank element, and the tank elements into a system. Several applications, including a subsea barge, a subsea hydro-electric plant and a hovering storage tank assembly are disclosed.

### BACKGROUND

Field of the Invention

The present invention generally concerns a subsea tank system, in particular a marine system with structural elements made of concrete. Primary applications are storage tanks and subsea barges for the offshore energy industry.

Prior and Related Art

Between 1975 and 1995, a series of Gravity Based Structures (GBS) of the Condeep (concrete deep water structure) platform type was built close to land and towed to their destinations in the North Sea. A Condeep structure rests on a cluster of large storage tanks for hydrocarbons, and comprises one, three or four shafts extending from the tanks at the sea bed to about 30 m above sea level. The storage tanks and shafts were made by vertical slip forming, a continuous casting process in which concrete is poured into formwork that is jacked slowly upwards as the concrete below hardens to sufficient strength.

In august 1991, a design flaw in the interconnected tanks of the Sleipner A platform caused the cluster of storage tanks to rupture, and the entire structure sank. [source: The Sleipner Platform Accident, B. Jakobsen, F. Rosendhal, Structural Engineering International 3/94] The rupture occurred at the tricell walls between three adjacent tanks. Differential water pressure acted on the tricell walls and resulting shear forces exceeded the load bearing capacity of the reinforcing steel in the tricell walls. In later designs, more reinforcing steel was added to the tricell walls and their supports towards the cell joints of the storage tanks. The largest Condeep platform, Troll A, was deployed in 1995 at over 300 m water depth, and has a total height of about 470 m. The Condeep platforms have provided valuable knowledge on structural design, materials and construction methods for marine concrete structures that can withstand the harsh and salty conditions in the North Sea.

A Condeep-platform is relatively expensive, mainly due to the long construction time of up to four years, the amount of steel in the reinforcement and the tall cranes and other special equipment required during its construction. After 1995, less expensive floating rigs and subsea production facilities have replaced the Condeep type platforms.

Marine concrete structures are still cost effective, e.g. as GBS for offshore oil and gas developments in arctic environments, liquefied natural gas (LNG) terminals, subsea tanks and, in particular, for immersed tunnels in relatively shallow waters. Immersed tunnels are assembled from tunnel elements pre-constructed on land. Tunnel element structures may, for example, comprise sections with a cross section 10×40 m² and length 120 m. The sections are placed end to end with a flexible gasket between them to create a watertight tunnel. The tunnel elements are designed such that one element is forced against the next by the water pressure.

Also, concrete technology has advanced. For example, ultra-high performance concrete (UHPC) is a high strength material lending itself to be utilized in deep sea constructions. More particularly, UHPC is a mixture of Portland cement, silica fume, quartz flour, fine silica sand, super-plasticiser, water, and steel or organic fibres. UHPC is characterised by compressive strengths above 150 to 200 MPa, high flexural strengths up to 45 MPa and creep coefficients of 0.2 to 1.0 which are much lower than creep coefficients of normal strength concrete. Other important UHPC characteristics are a high modulus of elasticity (above 45-55 GPa), low capillary porosity, resulting in very low water and gas permeability, and low diffusion of chloride ions, e.g. occurring in seawater.

Today, offshore production of oil and gas from the fields closest to land and in the most shallow waters, e.g. in the North Sea or Gulf of Mexico, diminishes as the fields are depleted. Thus, exploration and production of hydrocarbons move toward fields in deeper waters further from land, possibly in arctic regions such as the Barents Sea. These factors, i.e. longer distances, deeper waters and colder environments, favour autonomous subsea installations which take over some or all of the functions typically performed by surface based production installations on platforms or ships. A typical subsea installation comprises a production unit and storage tanks, both of which should be brought to the field at the lowest possible cost. At the field, the subsea installation may rest on a bed of gravel, which typically is prepared by a vessel with specialized equipment to deposit the gravel at the desired spot. This involves additional installation costs.

Barges for transport, subsea production platforms and storage tanks provide new opportunities for marine concrete structures, as reinforced concrete is generally less expensive than steel.

More particularly, the basic idea is to utilize advances in design and composition of marine concrete structures to solve technical challenges including cost, size and availability of vessels, e.g. for heavy lifting or depositing gravel; weather dependency; wave loads on large structures; lifting operations (air, wave zone, deepwater lowering); static and dynamic forces on cables and objects; heave compensation; landing on the seabed, retrieval; subsea assembly and testing; access and cost for inspection, maintenance and repair; spill response (ultra deep, arctic); long step-out power supply and storage of energy subsea.

In short, the purpose of the present invention is to solve at least one of the problems or challenges presented above while retaining the benefits of prior art.

### SUMMARY OF THE INVENTION

This is achieved by a subsea tank element according to claim 1, a tank system to according to claim 15 and a method for manufacturing according to claim 20.

In a first aspect, the invention concerns a subsea tank element comprising at least one tank section, the tank section(s) forming a cylindrical concrete-tank closed at its opposite ends by two end caps. The subsea tank element is distinguished by a rectangular structure surrounding the cylindrical tank and a connection between the rectangular structure and the cylindrical tank permitting a motion of the wall of the cylindrical tank within predetermined limits for deflection of the rectangular structure.

The concrete may be UHPC or any other known quality suitable for the application at hand. The rectangular structure facilitates connecting several tank elements into an array of buoyancy tanks or storage tanks. With a fixed distance and orientation of the tank elements relative to each other, fitting connections, pipes, pumps, valves etc. in an array of tank elements is trivial. If desired, several tanks, e.g. two or three tanks besides each other, can be surrounded by one rectangular structure.

The connection element permitting a limited relative motion of the cylinder walls relative to the rectangular structure ensures integrity of the tank element. In particular, the inner volume of the cylindrical tank may contain air at atmospheric pressure, such that the cylindrical tank compresses or expands radially in accordance with the ambient pressure or depth. For a tank element with a diameter of 10-20 m in deep waters, this radial deflection could be, for example, 50-100 mm. Thus, the radial deflection can cause severe strains, and must be accounted for in the design of a tank element according to the invention, as further discussed below.

If the cylindrical tank is not affixed to the rectangular structure, the cylinder may contract or expand depending on pressure without deflecting the rectangular walls. If the tank is affixed to the rectangular structure at some point, the point cannot move so far that the rectangular structure breaks or stress concentrations occur in the cylinder wall with possibly unfavourable shear or tensile stress.

In a preferred embodiment, the subsea tank element comprises longitudinal tensioning cables forcing the end caps together with sufficient force to ensure that the cylindrical tank is fluid tight under operational conditions. The required force is relatively small in applications where an external pressure forces the tank sections and end caps together during operation. As a concrete structure typically withstand large compressive stress, but is considerably more vulnerable to tensile or shear stresses, longitudinal tensioning cables, possibly combined with flexible elements between the sections and end caps, provide a desired flexibility. Tensioning cables can also carry tensile forces in the tank structure which may occur during construction, transport and installation. Tensioning cables may be led in ducts inside the cylinder wall or outside the cylinder wall, the latter allowing easy inspection and replacement during the structure's lifetime. If elastic deformations or plastic deformations from creep cause loss of initial tension, the tensioning cables can be tightened during the lifetime of the cylinder.

The rectangular structure preferably comprises at least one pre-stressed concrete slab forming any or all of a plane top plate, a bottom slab and a sidewall. Such concrete slabs are commercially available, and relatively inexpensive. Thus, using them for top, bottom and both sidewalls is a cost-effective alternative. However, the invention does not exclude using alternatives to such pre-stressed slabs at any or all sides of the rectangular structure. Thus, in principle, the rectangular structure can be made of, e.g. steel, non-pre-stressed walls of concrete or a monolithic structure of reinforces concrete.

If concrete slabs are used, each slab is preferably attached to the rectangular structure by a tensioning cable. This ensures flexibility for the reasons explained above.

In a second embodiment, the rectangular structure surrounding the cylindrical tank comprises a continuous floor cast on the site of assembly. The floor transfer horizontal forces in each tank element and reduces the need for tensioning cables. In embodiments with several tanks side by side in the rectangular structure, the floor also transfer horizontal forces between tank elements, further reducing the need for tensioning cables in the rectangular structure.

Embodiments with a continuous floor may comprise a load bearing structure on the floor and/or a ceiling in the rectangular structure, wherein the load bearing structure is configured to carry a vertical force imposed by the cylindrical tank and to permit a relative motion caused by pressure variations. Load bearing structures on the continuous floor might be useful in applications, e.g. on the seafloor, where the weight of the tank provides a net downward force. Similar load bearing structures on a ceiling of the rectangular structure might be useful in applications, e.g. subsea barges, where the buoyancy of the tank impose a net load on the ceiling of the rectangular structure. These load bearing structures are not mandatory as alternative means, e.g. suspension, are generally known. If present, the load bearing structure may be regarded as a special case of the connection between the rectangular structure and the cylindrical tank. Specifically, as a continuous floor does not expand or contract due to pressure, one or more cylindrical tank(s) resting on the floor must be able to move relative to the floor. The same conditions apply to a structure on the ceiling taking a load in the opposite direction.

The second embodiment preferably also comprises a wall cast on the site of assembly, i.e. any side or end wall. The purpose is to create a structure capable of transferring vertical forces in addition to the horizontal forces in and between tank elements, thereby further reducing or eliminating the need for tensioning cables in the rectangular structure.

The connection between the rectangular structure and the cylindrical tank may comprise a longitudinal protrusion on the outer surface of the cylindrical tank and ribs mounted above and/or below the protrusions on the surfaces facing the tank. The protrusions and ribs transfer net vertical forces up and/or down from the cylindrical tank to the rectangular structure. In one example, cast walls facing the tank comprise ribs above and below the protrusions along the tank replace the load bearing structure on the floor and the ceiling. In another example, a load bearing structure on the floor is provided to carry a heavy load most of the time and a rib above the protrusion prevents the tank from floating to the top of the rectangular structure. In a subsea barge, the large force would be imposed on the ceiling. Thus, the actual configuration is a design issue depending on the intended application for the tank element.

Regardless of construction, the tank element may comprise a skirt for settling in seafloor sediments. In use, the skirt transfers horizontal forces to the seafloor and thereby stabilises the tank element. The tank element may further comprise openings for injecting cement into the skirt during installation on a seafloor. The purpose is to fill cement into any space between the sediments and the bottom of the tank element, thereby providing a firm and stable fundament for a tank element permanently deployed on the seafloor.

In a preferred embodiment, a space between the lower half of the outer surface of the cylindrical tank and the rectangular structure contains a first permanent ballast. Furthermore, a similar space between the upper half of the outer surface of the cylindrical tank and the rectangular structure may contain a second permanent ballast.

The main objectives of the permanent ballast is firstly to provide a near neutral buoyancy for the entire tank element, and secondly to place the centre of mass below the centre of buoyancy for static stability. Both of these objectives can be met by using sand or gravel of, for example and in increasing order of cost and density: granite, eclogite, olivine or magnetite. Additionally or alternatively, the thickness of the bottom slab may be increased for ballasting purposes. The choice of ballast material depends on numerous factors, and must be left to the skilled person knowing the application at hand. The filling of the ballast space with the chosen ballast material may be performed in a cost-effective way on the construction site, e.g. in a dry dock, with commercially available equipment such as cranes or conveyor belts. Installing the majority of the permanent ballast on-shore or near shore is much more cost effective than, for example, placing ballast by a subsea rock installation from a special purpose flexible fall pipe vessel commonly used in pipeline rock installations.

In a particularly preferred embodiment, the second permanent ballast has less density than the first permanent ballast. This includes an embodiment wherein the second permanent ballast is water, e.g. an embodiment wherein water is permitted to flow through the rectangular structure in order to equalize pressure, permanent ballast is only provided in the lower half of the tank element.

As noted, the permanent ballast preferably provides near neutral buoyancy. Preferably, the buoyancy is slightly positive to facilitate towing as described below, and the subsea tank element accordingly comprises a ballast tank for water in order to adjust the buoyancy from slightly positive to slightly negative as known in the art. The ballast tank can comprise several lengths of commercially available pipes for additional reduction of cost. The ballast tank provides an important function in control of buoyancy at greater water depths to compensate for change of cylinder buoyancy due to hydrostatic wall compression and change in cylinder displacement.

In a second aspect, the invention concerns a subsea tank system comprising at least two subsea tank elements according to any preceding claim connected to form a platform.

Thus, several tank elements can be connected into a platform or barge for heavy loads. Such a platform can be provided with slightly positive buoyancy in order to float at the surface. Alternatively, the platform can be provided with slightly negative buoyancy and the buoyancy required to keep it floating can be provided through buoys, e.g. vertical cylindrical elements, at the surface. In the latter case, the subsea barge may keep a load below the wave zone, i.e. such that waves and surface conditions affect the buoys only. This eliminates, for example, wave loads and icing on the platform and/or its cargo. In either case, tensile forces are taken up by the tensioning cables or an integrated structure, and the platform provides a flat and stable support for the cargo.

The tank system may further comprise a network of pipes, pumps and valves for interconnecting the tank elements.

Some embodiments with a network interconnecting the tank elements comprise equipment for using the tank elements as storage tanks, e.g. for oil or gas. Such equipment is well known in the art, and may include a line to a loading buoy on the surface.

Other embodiments comprise equipment for using the tank elements as low-pressure tanks in a deepwater pumped storage hydroelectric plant. Again, the equipment is well known in the art, and may include a ventilation line to the surface. In particular, the head at 300-1200 meters corresponds to the head from a water reservoir in a mountain, so that single or multistage turbines for this range are well proven and commercially available from several vendors.

Still other embodiments further comprise equipment for using the tank system as a platform for a marine installation. The term “marine installation” implies any application at sea wherein the tank elements are used as housing or platform for equipment. The tank elements can, for example, be used as housing for a long step-out power supply, a transformer or converter station, subsea hydrocarbon separation and processing equipment, living quarters for a crew, etc. In another example, the system can be used as a platform for large equipment, e.g. a gas compression unit or fluid pump, at the seafloor. These embodiments do not necessarily need interconnected tanks. However, a controllable network might be useful for balancing ballast water.

In a third aspect, the invention concerns a method for manufacturing a subsea tank system, comprising the steps of: casting a cylinder for a tank section; casting end caps for closing a tank element; assembling a fluid tight tank from at least one cylinder for a tank section and exactly two end caps; arranging a rectangular structure around the fluid tight tank; and connecting the rectangular structure with the cylindrical tank such that the wall of the cylindrical tank is permitted to move within predetermined limits for deflection of the rectangular structure.

This method allows several concrete cylinders and end caps to be cast and cured simultaneously, whereby the production time is reduced significantly compared to the traditional slip forming method of monolithic structures used for e.g. the Condeep platforms discussed in the introduction. Furthermore, the casting can be performed indoors under favourable conditions for the chosen quality of concrete, e.g. UHPC. The tank element is conveniently assembled in a dry dock or on a slip, or alternatively in water near a casting hall.

In one embodiment, the method further comprises the step of towing the subsea tank element to a system assembly site.

In an alternative embodiment, arranging a rectangular structure around the fluid tight tank involves casting a continuous floor for at least one tank element in a drydock and assembling the cylindrical tank on the casted floor.

In both embodiments, the method preferably further comprises the step of providing the tank element with equipment according to any embodiment in the second aspect of the invention.

The system assembly site may, of course, be close to the production site and/or the site of deployment depending on the size of the system and on the application.

Other features and advantages will become clear from the accompanying claims and the following detailed description.

### BRIEF DESCRIPTION OF THE DRAWINGS

The invention will be explained in greater detail by way of exemplary embodiments with reference to the accompanying drawings, in which:

FIG. 1 is a cross sectional view of a tank section;

FIG. 2 illustrates several tank sections forming part of a tank element;

FIG. 3 illustrates several tank elements forming part of a subsea platform system;

FIG. 4 illustrates differential ballasting;

FIG. 5 shows the system configured as a barge;

FIG. 6 shows a configuration as a subsea energy installation;

FIG. 7 illustrates a system with internal payload;

FIG. 8 illustrates the system configured as a tunnel;

FIG. 9 illustrates the system used as a landing platform for a subsea carrier,

FIG. 10 illustrates a second embodiment of the tank element;

FIG. 11 illustrates a method for casting tank sections on site;

FIG. 12 illustrates a method for casting a structure according to the second embodiment;

FIG. 13 illustrates a method for assembling a tank element;

FIG. 14 illustrates an alternative method for assembling a tank element; and

FIG. 15 illustrates a method for assembling a system comprising several tank elements.

### DETAILED DESCRIPTION

The drawings are schematic, and merely intended to illustrate the principles of the invention. Thus, they are not necessarily to scale, and numerous details obvious to one skilled in the art are omitted for clarity.

The reader should keep in mind that a typical tank element described below has cross-sectional dimensions that may exceed 20 m and lengths that may exceed 100 m. Hence, replacing expensive steel with less expensive concrete wherever possible has a significant effect on manufacturing costs. The savings multiply as several tank elements are combined into a tank system. Similarly, forces, deflections and other parameters acting on a large structure are not directly comparable to those acting on a smaller structure. Accordingly, effects that are trivial in a small structure can be significant in a larger structure. Furthermore, the articles “a”, “an” and “the” as used herein, in particular in the claims, mean “at least one”, whereas “one” means exactly one.

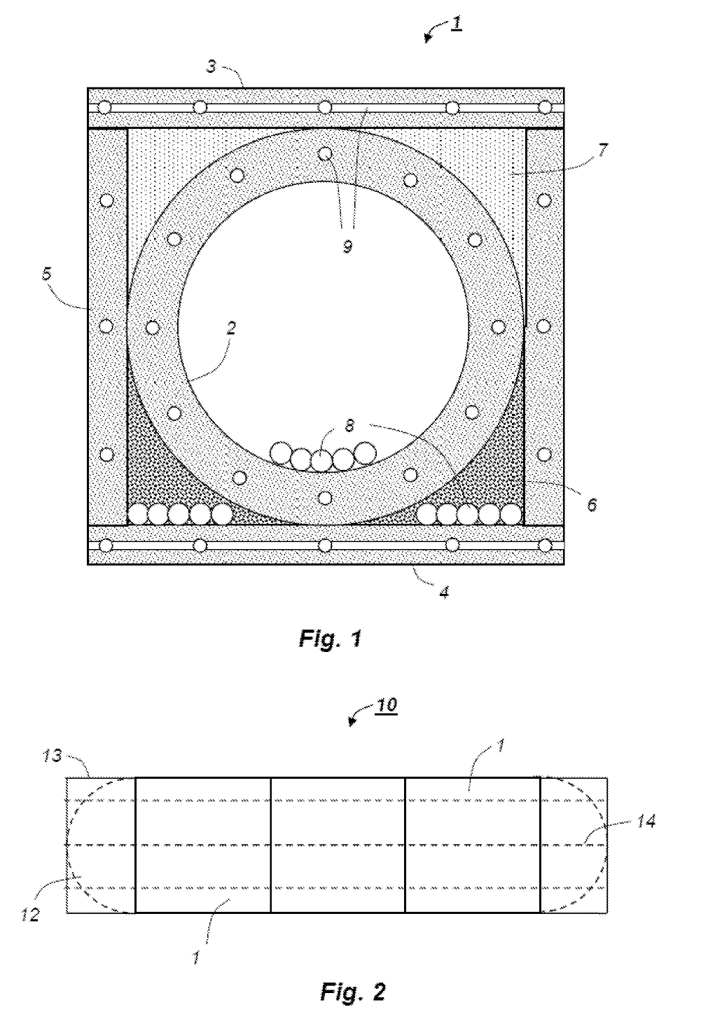

FIG. 1 is a cross sectional view of a sub sea tank section 1 according to the invention. It comprises part of a cylinder 2, a plane top plate 3 disposed above the cylinder 2, a bottom slab 4 disposed below the cylinder 2 and two sidewalls 5 on either side of the cylinder 2. According to the invention, the complete tank element comprises a cylindrical tank surrounded by a rectangular structure. Thus, it should be understood that the cylindrical tank may have sidewalls 5 at both ends in addition to the sidewalls 5 shown in FIG. 1. If desired, one tank section can comprise several cylinders 2 side by side, yielding a tank element with several tanks 2. Also, the rectangular structure may comprise several slabs each, e.g. precast slabs each measuring 1.2×20 m² collectively surrounding a tank with diameter 20 m and length 100 m, or alternatively one or more monolithic structure(s) of reinforced concrete or a steel structure. However, one tank element per rectangular structure provides maximum flexibility, and reinforced concrete is generally less expensive than steel, both of which are desirable.

The outer shape of the cross section is essentially rectangular so that several tank sections 1 conveniently can be connected beside each other to form a larger platform with a plane top. In some applications, the inner volume of the cylinder 2 may contain air at atmospheric pressure for buoyancy. In other application, the inner volume may contain oil or gas at approximately ambient pressure. Accordingly, the wall thickness of the cylinder must be adapted to the operational pressure difference. In addition, there may be a desire to increase the wall thickness for safety reasons and/or to add weight in order to reduce the need for permanent ballast. As noted, the top plate 3, bottom slab 4 and sidewalls 5 are preferably made of reinforced concrete. In many applications, this concrete can be a less expensive quality than the concrete in the cylindrical concrete-tank 2. For example, the rectangular structure may permit water to enter the space between the cylinder 2 and the rectangular structure 3, 4, 5 such that the pressure will be equal on both sides of the rectangular walls. If the cylinder 2 is flexibly attached to the rectangular walls 3, 4 and 5, it may contract and expand without causing significant deflection on the rectangular walls. Hence, concrete with a broad range of tensile or flexural strength will withstand the pressure at any practical depth, and other design criteria determine the quality and reinforcement of the concrete in the rectangular walls. For example, it may be desirable to increase the thickness and/or density of the bottom slab 4 to save on permanent ballast 6, or to increase the thickness and/or ductility of the top plate 3 to accommodate heavy loads.

In claim 1, the connection between the rectangular structure 3, 4, 5 and the cylindrical tank 2 comprises any element transferring a force between the rectangular structure and the cylinder 2, including optional supports for adjacent slabs, beams for distributing loads etc. Such elements are not shown in the figures for clarity. However, the choice and configuration of elements is a design issue that must be left to the skilled person knowing the application at hand, and must of course be designed such that radial motion of the cylinder wall due to pressure does not harm or tear apart the cylinder wall or the rectangular structure. This connection also allows certain compression-induced radial strains (radial motions) to occur in the cylinder wall and avoids large tensile or shear stress in the cylinder walls, which would otherwise have to be to controlled by heavy steel reinforcement. Thus, the cylinder wall may be constructed in a simplified and cost effective method with little or no conventional steel reinforcement, beyond fibres.

For the cylindrical tank, ultra high performance concrete (UHPC) with fibres can be a cost effective alternative to traditional reinforced concrete with passive reinforcing steel, especially in deepwater applications with large pressure differences over the walls of the tank 2. In particular, during manufacture it is difficult and time consuming to ensure that concrete fills all spaces within a rebar cage, whereas UHPC essentially can be poured into a mould with little or no rebars. In deep water applications, compression of a tank may cause a significant loss of displacement and buoyancy, which must be carefully monitored and compensated. UHPC helps reducing this problem as it is stiffer, i.e. has a higher module of elasticity, than other qualities of concrete. On the other hand, UHPC with fibres is not likely to withstand other forces, e.g. longitudinal forces that occur during towing, as good as concrete with a large amount of steel reinforcement. However, this can be handled in a convenient manner, e.g. by adding tension cables within or outside the cylindrical tank to take up longitudinal forces. As above, the choice of concrete quality and reinforcement depends on the application at hand, and is left to the skilled person.

The top 3, bottom 4 and sidewalls 5 are preferably made of commercially available precast and pre-stressed hollow rectangular concrete slabs. If desired, the hollow spaces within such slabs can be sealed off to provide cells for extra ballast or buoyancy. In deep water applications, such cells might initially be filled with ballast water. When lowering such a cell in the sea, the ballast water could gradually be replaced with pressurised air as the pressure from the water column causes the cylindrical tank to contract, and hence decreases the displacement and buoyancy. In such an application, the air must have a sufficiently large pressure to avoid that the hollow slabs collapse from the external pressure. Supplying air from the surface at such pressures, attaching the required lines to a cell within a concrete slab and other problems may render it impractical to use the hollow spaces for ballast in deep water applications. However, extra cells for buoyancy can be useful during towing, completion, harbour work and other operations where the tank element is close to the surface.

Preferably, the centre of mass is below the centre of buoyancy to ensure static stability. This can be achieved, for example, by increasing the weight of the bottom slab 4, or by using permanent ballast 6 with high density in the lower space between the outer cylinder wall and the bottom slab 4 and sidewalls 5 as shown in FIG. 1. Examples of suitable ballast 6 include, in increasing order of density and cost: Sand, gravel, eclogite, olivine and magnetite. The corresponding upper volume, shown at reference numeral 7, can be filled with less dense ballast such as sand, gravel or sea water.

One or more tank sections 1 can be combined into a tank element 10 as further described in connection with FIG. 2. Optional ballast tanks 8, e.g. in the form of pipes extending along such a tank element 10, can be provided within the cylindrical volume and/or be embedded in ballast 6.

Longitudinal and lateral cable channels 9 are provided for post tensioning and connection to adjacent tank sections and elements as further described below. During assembly, steel cables are drawn through these channels and provided with a predetermined tension before the channels 9 can be filled with grout or grease for corrosion protection. Techniques for such post tensioning are well known, and thus not discussed in greater detail herein.

FIG. 2 illustrates a tank element 10 comprising three tank sections 1 of the kind described above. Of course, any suitable number of tank sections can be combined into a tank element 10. The inner cylinder is closed by end caps 12 at both ends, e.g. by hemispherical end caps 12 as illustrated by dotted lines in FIG. 2. The tank element 10, including end slabs 13 to provide a rectangular outer shape, is held together by tensioning cables 14 running through some or all cable channels 9 in FIG. 1. Further, there may be less need for tensioning cables in applications wherein an external pressure forces the tank sections 1 and end caps 12 together than in applications where the internal pressure is approximately equal to or greater than the ambient pressure.

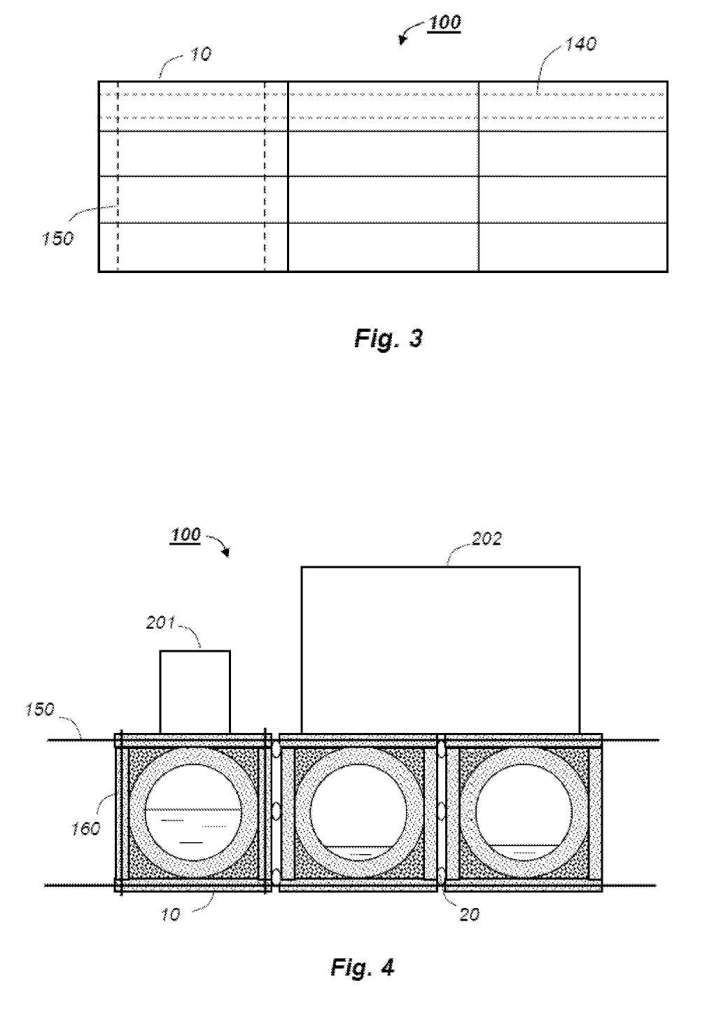

FIG. 3 shows a subsea platform 100 comprising an array of rectangular tank elements 10 connected by longitudinal cables 140 and lateral cables 150. As shown in FIG. 4, flexible elements 20 can favourably be disposed between adjacent elements 10. By controlling the tension in the cables 140, 150 and selecting a suitable material, e.g. an elastomer for the flexible elements 20, the entire subsea platform 100 can be provided with an appropriate flexibility and still provide a reasonably plane and stiff top face.

FIG. 4 shows a part of an assembled platform 100 with flexible elements 20 between the tank elements 10 and lateral tensioning cables 150 at the top and bottom. A load 201 with relatively small mass is located over a tank element with a relatively large amount of ballast water. A large load 202 is disposed over two tank elements 10, each having a less amount of ballast water. Preferably, the mass sum of a load 201, 202 and the ballast water within the tank element below is approximately constant to avoid tensile and shear stress, or static instability caused by different buoyancy at different places on the platform.

In the leftmost tank element 10, tensional cables 160, e.g. steel wire, run from top to bottom through the sidewalls. These cables tie the top plate 3 to the bottom slab 4, and also keep the sidewalls 5 in place. Similar cables 160 also connect the top and bottom slabs of the other tank elements and sections, but are not shown for clarity.

In addition to the compression forces discussed above, the loads applied during assembly, towing and lowering/lifting must also be accounted for. For example, the tank elements 10 and/or system 100 may be designed such that the rectangular structure 3, 4, 5 takes the load during assembly and towing. In this case, a tank made of fibre reinforced UHPC does not need to be designed for the relatively large tensile loads that may occur during towing.

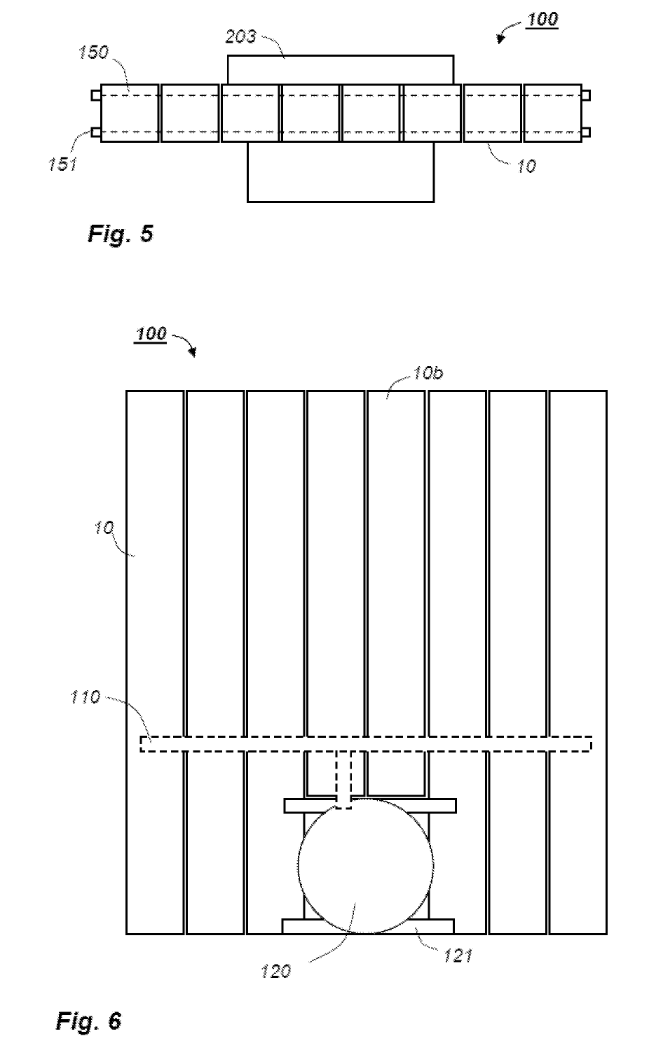

FIG. 5 illustrates the system 100 configured as a barge for a large payload 203. For static stability, more particularly to keep the centre of mass below the centre of buoyancy, the load 203 extends through a central opening in the system 100. The tank elements 10 and tensioning cable 150 are described above. The elements 151 depict anchors keeping the tension in cable 150 as known in the art.

FIG. 6 illustrates a generic application for the energy industry, in particular at the seafloor. In addition to the tank elements 10, the system 100 comprises a network 110 of pipes, valves and pumps, as well as some extra equipment 120, 121. The two shorter tank elements 10b illustrates that the tank elements 10, 10b can be of different lengths. FIG. 6 can illustrate two different examples of use.

The first example is a hydroelectric plant operating at a seafloor in 300-1200 m depth, which roughly corresponds to the head from a traditional water reservoir of a pumped storage plant in a mountain. Single or multistage reversible pump turbines for this range are well proven and commercially available from several vendors. In this example, the equipment 120 depicts a turbine unit, the tank elements 10, 10b are low pressure tanks, and the network 110 allows pressurised water into the tank elements through the pump turbine unit 120. The elements 121 are connecting beams. Such a hydroelectric power plant can advantageously comprise a ventilation line to the surface.

In the second example illustrated by FIG. 6, the equipment 120, 121 is a wellhead for a production well for oil and/or gas, and the network 110 distributes the produced fluid to storage tanks within the tank elements 10, 10b. The network 110 may comprise a line to a loading buoy at the surface for a surface carrier, or alternatively a similar connection at the seafloor for a subsea carrier.

In some embodiments of a system 100 at the seafloor, e.g. as shown in FIG. 6, the platform comprised of the tank elements 10, 10b may advantageously comprise several heavy chains (not shown) hanging from the platform and lying on the seafloor. If the platform starts to rise, the chains are lifted from the seafloor and the added weight pulls the platform down to its intended depth. Conversely, if the platform starts to sink, more of the chains come to rest on the seafloor, and the reduced weight causes the platform to return to the equilibrium, i.e. neutral buoyancy for the system as a whole. An advantage of mooring the tank element at the sea floor without direct contact to the sediment is the kinematic decoupling from the ground, which protects the tank structure from destructive excitation in the case of earthquakes. Another advantage can be the avoidance of a costly soil preparation, e.g. by a subsea rock installation.

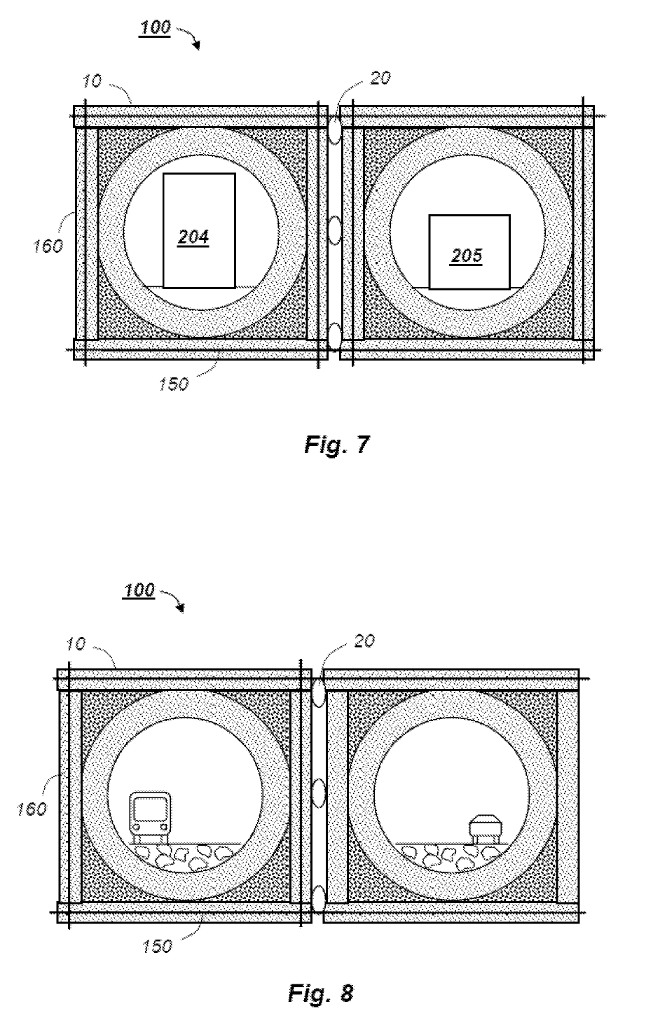

FIG. 7 illustrates that a payload 204, 205 can be placed inside a tank element 10. For example, a tank element 10 can comprise living quarters 204 for a crew, a generator/transformer/AC-DC converter 205 for a long step-out power supply etc.

FIG. 8 shows yet another example of use, in which two tank elements 10 provide a subsea tunnel with two lanes in each element; one tank element 10 for traffic in one direction and the other tank element for traffic in the opposite direction. Due to the cylindrical shape and the pressure tight structure, such a tunnel will withstand greater depths than tunnels with rectangular cross sections.

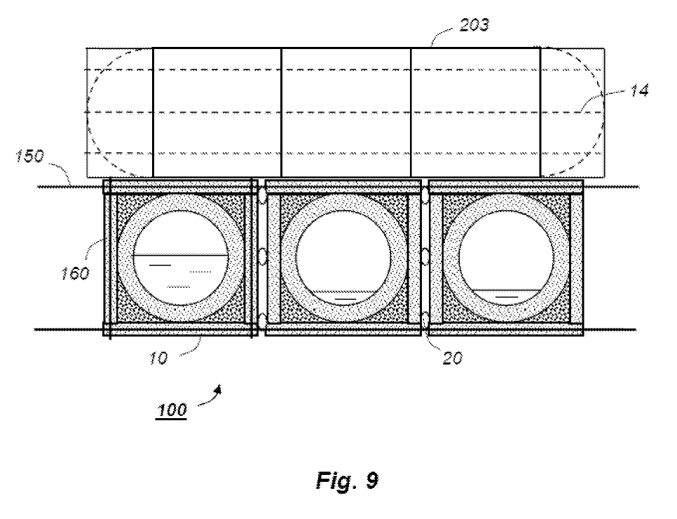

FIG. 9 illustrates a subsea landing platform 100 for a subsea carrier 203 for hydrocarbons. In this application, the platform 100 provides buoyancy for the subsea carrier 203. The platform 100 might be deployed at, for example, a depth of 2 500 m and would comprise connections for loading and unloading hydrocarbons and ballast for the subsea carrier 203. Corresponding lines to the surface connects the platform 100 to networks for hydrocarbons and air. The platform 100 may also provide storage capacity for hydrocarbons. The subsea carrier 203 can be a modified version of the tank element shown in FIG. 2. Tension cables 14 illustrate that the load during towing of the subsea carrier must be accounted for.

It should be understood that the examples presented above are just some of numerous applications.

As noted, several cylinder sections 2 and end caps 12 for the tank can be cast and cured simultaneously, preferably in a production hall with favourable conditions, and then assembled to the tank element 10 shown in FIG. 2.

Referring back to FIG. 2, a tank element 10 comprises several tank sections 1 and two end sections 12, 13. If launched from a slip, a long tank element 10 will be suspended from both ends. This imposes loads not encountered during normal operation, and may cause leaks. Thus, it may be desirable to assemble a long tank element 10 horizontally, e.g. in a dry dock. Other reasons for assembling the tank element 10 in a dry dock is speed, the possibility of casting a rectangular structure using traditional formworks, the possibility of assembling two or three tank elements side by side in a typical dry dock, etc. However, a dry dock is not an absolute requirement. For example, embodiments with a connection to a piped network may conveniently be emptied by means of a bilge pump, and may even be assembled in the water.

After assembly, the tank element 10 is typically towed to a system assembly site where it is connected into a system 100, and where the system 100 is fitted out according to its intended purpose.

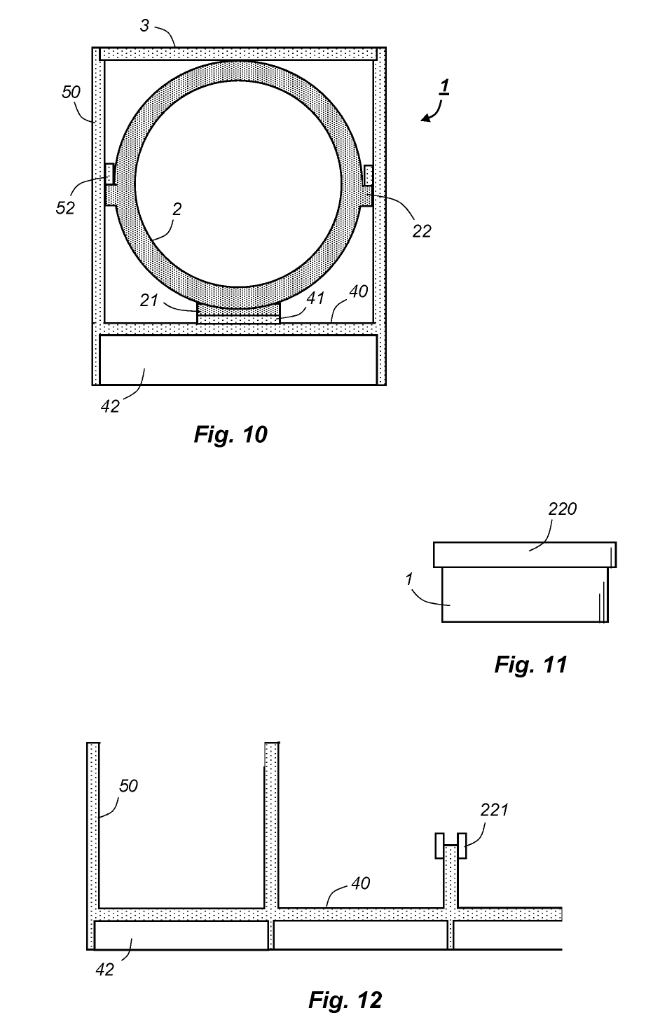

FIGS. 10-15 illustrate an alternative embodiment of the tank element 10 and system 100, in which a floor 40 is cast as one, continuous element on the site of assembly. Preferably, some or all of the walls 50 are cast as part of one, integrated concrete structure 40, 50 with compartments for the cylindrical tanks 2. This structure eliminates the need for tensioning cables 140, 150, 160, elastic element 20 etc. to connect the tank elements 10 in the previous embodiment.

Similar to FIG. 1, FIG. 10 is a cross section through a tank 2 surrounded by a rectangular structure. Ducts 9 for cables along the tank 2 are not shown in FIG. 10, but are still provided in a preferred embodiment. Tensioning cables are practical to hold the tank sections 1 together until they are forced together by water pressure.

In contrast to the previous embodiment, the floor 40 and walls 50 form a continuous concrete structure or caisson along the entire length of the tank 2, so this embodiment does not need the tensioning cables 140, 150, 160 connecting the rectangular structure as described with reference to FIGS. 3 and 9. In FIG. 10, reference numerals 21 and 41 illustrate support structures associated with the cylinder 2 and floor 40, respectively. The purpose of the structures 21, 41 is to carry the weight of tank 2 on the floor 40, and to permit relative motion as the tank 2 contracts and expands longitudinally due to pressure. Such support structures 21, 41 may have any suitable form and shape.

The only other connection between the rectangular structure 40, 50 and the cylindrical tank 2 are longitudinal protrusions 22 on the outer surface of tank 2 and ribs 52 mounted on the surfaces facing the tank 2 and above the protrusions 22. The ribs 52 on the fixed walls prevent the tank from reaching the top or ceiling of the rectangular structure, and may be regarded as structures transferring buoyancy. By symmetry, structures on the ceiling bearing buoyancy and structures on the walls transferring gravity loads are anticipated.

The caisson 40, 50 is provided with a skirt 42. During towing, the skirt 42 may be filled with compressed air to provide additional buoyancy to the caisson. In use, the skirt 42 will settle in the seafloor sediments. In some embodiments, the skirt 42 may be allowed to settle for some time after deployment before cement is injected to fill any spaces left between the seafloor sediments and floor 40. The injection is similar to that used in cementing a casing to seafloor sediments in the oil and gas industry, so suitable cements or compositions are commercially available.

FIG. 11 illustrate casting a cylindrical tank section 1 by means of a slip form 220. Several such sections may be cast in parallel in a suitable location as discussed above. FIG. 12 illustrate casting a wall 50 of the caisson 40, 50 by a slip form 221. Casting several sections of the cylinder 2 and the caisson 40, 50 in parallel reduces construction time.

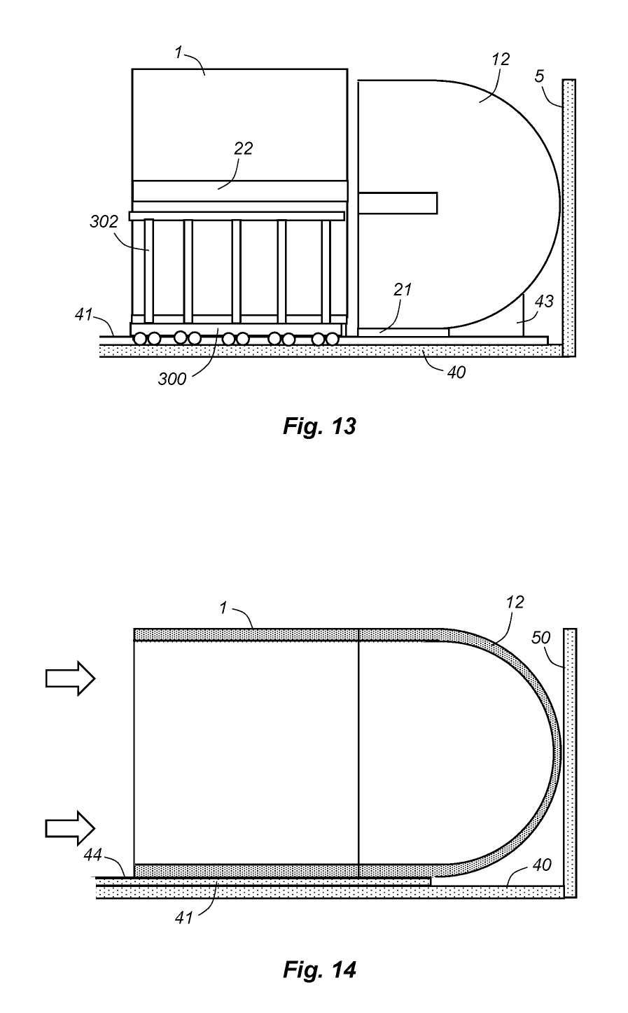

FIG. 13 illustrates using a self-propelled modular transporter (SPMT) 300 and a suitable steel cradle 302 to move a tank section 1 during assembly. FIG. 13 also show an optional support 43 for the end cap 12 different from the general support 41 for the cylindrical elements.

FIG. 14 illustrate an alternative method of assembly using sliding beams 44. In addition or alternatively, sliding beams 44 may be mounted to reduce friction, and hence load on the joints between sections, when the tank 2 contracts and expands due to pressure variations. There should be no pressure difference across end wall 50, and hence no net force causing it to deflect. For the same reason, the end cap 12 is not attached to wall 50.

FIG. 14 also illustrates that the endcap 12 has thinner walls at the end facing the end wall 50 than at the end facing the cylinder section 2. The purpose is to ensure uniform contraction and expansion over the tank element 10. For example, the radial contraction of a hemisphere with uniform wall thickness will be less than that of a cylinder with the same wall thickness if exposed to the same radial forces or pressure. The endcap is not necessarily hemispherical, and the reduced thickness must be determined during design based on shape and other parameters known in the art.

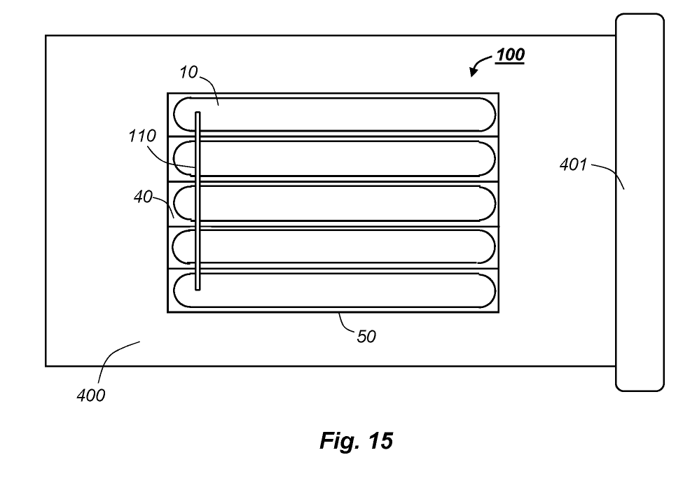

FIG. 15 shows a dry dock 400 with a gate 401 and a system 100 comprising a caisson with cast floor 40 and walls 50. The tank elements 10 are connected by a network of pipes 110 to illustrate that a dry dock 400 is convenient for mounting any equipment. For a numerical example, each tank element 10 in FIG. 15 might be 25 m by 200 m. A tank unit provided by the caisson 40, 50 with five integrated tank elements 10 would be about 130 m by 200 m. This will require a large dry dock 400, but such docks are available. In addition to a sufficiently large dry dock, a suitable assembly site should have nearby facilities to cast and cure several tank sections in parallel. For example, moving heavy elements 20 meters in diameter on an SPMT at a few km/h prevent regular transport over long distances and on public roads.

The invention has been described with reference to exemplary embodiments. However, the scope of the invention is defined by the accompanying claims.

1-23. (canceled)

24. A subsea tank element comprising:
at least one tank section, the tank section(s) forming a cylindrical concrete-tank closed at its opposite ends by two end caps,
a rectangular structure surrounding the cylindrical tank, and
a connection between the rectangular structure and the cylindrical tank permitting a motion of the wall of the cylindrical tank within predetermined limits for deflection of the rectangular structure.

25. The subsea tank element according to claim 24, further comprising longitudinal tensioning cables forcing the end caps together with sufficient force to ensure that the cylindrical tank is fluid tight under operational conditions.

26. The subsea tank element according to claim 24, wherein the rectangular structure comprises at least one pre-stressed concrete slab forming any or all of a plane top plate, a bottom slab and a sidewall.

27. The subsea tank element according to claim 26, wherein each concrete slab is attached to the rectangular structure by a tensioning cable.

28. The subsea tank element according to claim 24, wherein the rectangular structure surrounding the cylindrical tank comprises a floor cast on the site of assembly.

29. The subsea tank element according to claim 28, further comprising a load bearing structure on the floor and/or a ceiling in the rectangular structure, wherein the load bearing structure is configured to carry a vertical force imposed by the cylindrical tank and to permit a relative motion caused by pressure variations.

30. The subsea tank element according to claim 24, wherein the rectangular structure surrounding the cylindrical tank comprises a wall cast on the site of assembly.

31. The subsea tank element according to claim 24, wherein the connection between the rectangular structure and the cylindrical tank comprises a longitudinal protrusion on the outer surface of the cylindrical tank and ribs mounted above and/or below the protrusions on the surfaces facing the tank.

32. The subsea tank element according to claim 24, further comprising a skirt for settling in seafloor sediments.

33. The subsea tank element according to claim 32, further comprising openings for injecting cement into the skirt during installation on a seafloor.

34. The subsea tank element according to claim 24, wherein a space between the lower half of the outer surface of the cylindrical tank and the rectangular structure contains a first permanent ballast.

35. The subsea tank element according to claim 34, wherein a space between the upper half of the outer surface of the cylindrical tank and the rectangular structure contains a second permanent ballast.

36. The subsea tank element according to claim 35, wherein the second permanent ballast has less density than the first permanent ballast.

37. The subsea tank element according to claim 24, further comprising a ballast tank for water.

38. A subsea tank system comprising at least two subsea tank elements according to claim 24, the tank elements connected to form a platform.

39. The subsea tank system according to claim 38, further comprising a network of pipes, pumps and valves for interconnecting the tank elements.

40. The subsea tank system according to claim 39, further comprising equipment for using the tank elements as storage tanks.

41. The subsea tank system according to claim 40, further comprising equipment for using the tank elements as low-pressure tanks in a deepwater hydroelectric plant.

42. The subsea tank system according to claim 40, further comprising equipment for using the tank system as a platform for marine installations.

43. A method for manufacturing a subsea tank element according to claim 24, comprising the steps of:
casting a cylinder for the tank section;
casting end caps for closing the tank element;
assembling the fluid tight cylindrical tank from at least one tank section and exactly two end caps;
arranging the rectangular structure around the cylindrical tank; and
connecting the rectangular structure with the cylindrical tank such that the wall of the cylindrical tank is permitted to move within predetermined limits for deflection of the rectangular structure.

44. The method according to claim 43, further comprising the step of towing the subsea tank element to a system assembly site.

45. The method according to claim 43, wherein arranging the rectangular structure around the fluid tight tank involves casting a continuous floor for at least one tank element in a dry dock and assembling the cylindrical tank on the casted floor.

46. The method according to claim 43, further comprising the step of providing the tank element with equipment.
